(19) United States
(12) Patent Application Publication
(10) Pub. No.: US 2016/0053096 A1
(43) Pub. Date: Feb. 25, 2016

(54) ECO-FRIENDLY SOFT MBS RESIN COMPOSITION AND VINYL LEATHER USING THE SAME

(71) Applicant: YOUNGIL CO. LTD., Gwangju City (KR)

(72) Inventor: Ho-Young LEE, Namyangju-si (KR)

(21) Appl. No.: 14/593,567

(22) Filed: Jan. 9, 2015

(30) Foreign Application Priority Data
Aug. 19, 2014 (KR) 10-2014-0107912

(51) Int. Cl. C08L 9/06

(52) U.S. Cl. CPC C08L 9/06

(57) ABSTRACT

The present invention relates to an eco-friendly soft methylmethacrylate butadiene styrene (MBS) resin composition and a vinyl leather using the same and, more particularly to, an eco-friendly soft MBS resin composition and a vinyl leather using the same that include a methacrylate butadiene styrene (MBS) resin, a vegetable oil, and a thermoplastic polyester elastomer resin, thereby securing eco-friendliness without giving off environmental hormone disruptors and also offering excellent properties in regards to weatherability, low-temperature resistance, heat resistance, tensile strength, elongation at break, scratch resistance, adhesiveness, and wear resistance.

### TECHNICAL FIELD

The present invention relates to an eco-friendly soft methylmethacrylate butadiene styrene (MBS) resin composition and a vinyl leather using the same and, more particularly to, an eco-friendly soft MBS resin composition that includes a methacrylate butadiene styrene (MBS) resin, a vegetable oil, and a thermoplastic polyester elastomer resin, and a vinyl leather using the same.

### BACKGROUND ART

Polyvinyl chloride (PVC) is commonly used as a raw material to produce artificial leather (i.e., vinyl leather) due to its good processability and excellent properties in regards to weatherability, tensile strength, elongation at break, scratch resistance, adhesiveness, wear resistance, etc.

With the recent environmental issues, it is a tendency to limit or ban the use of polyvinyl chloride (PVC). And yet, no alternative material to PVC exists and PVC is still widely used in the manufacture of bags, constructional or advertising products, or the like.

Particularly, when PVC is used in lamination with fabrics to make products such as artificial leather, the products are more difficult to recycle and mostly subjected to incineration, which leads to problems in regards to the environment and cost.

As a solution to this problem, many attempts have been made to replace the soft PVC resin. But the PVC alternatives are far from complete and no complete PVC alternative exists.

On the other hand, the methylmethacrylate butadiene styrene (MBS) resin is produced in the form of powder through graft copolymerization of styrene and methacrylate monomers in the presence of rubber latex and mainly used as a shock absorber or other adjuvants for hard PVC, engineering plastic, or other resins.

The PVC resin is one of the most widely used resins, because it is readily miscible with a liquid raw material such as a plasticizer and good at compatibility and has good properties and processability as acquired by softening, making it possible to form soft products with high quality. The MBS resin is not easy to soften and, even if softened, deteriorates in properties, so it is impossible to process into commercial products.

Accordingly, there is a demand for studies on the method for compensating for the problems with the MBS resin and replacing all kinds of soft PVC products.

### PRIOR ART

### Patent Documents

(Patent Document 1)

Korean Open-Laid Patent No. 10-2008-0037904

### DISCLOSURE OF INVENTION

In order to solve the problems with the prior art, it is an object of the present invention to provide an eco-friendly soft MBS resin composition that does not give off environmental hormone disruptors unlike the existing PVC resins, and a vinyl leather using the same.

It is another object of the present invention to provide an eco-friendly soft MBS resin composition and a vinyl leather using the same, where the eco-friendly soft MBS resin composition has excellent properties in regards to weatherability, low-temperature resistance, heat resistance, tensile strength, elongation at break, scratch resistance, adhesiveness, and wear resistance and is thus suitable as an alternative material to replace the soft PVC films, sheets, toys, and medical products, as well as bags and constructional or advertising products that conventionally use the existing PVC-based synthetic leather.

To achieve the objects of the present invention, there is provided an eco-friendly soft methylmethacrylate butadiene styrene (MBS) resin composition that includes: 100 parts by weight of a MBS resin; 20 to 130 parts by weight of a vegetable oil; and 3 to 150 parts by weight of a thermoplastic polyester elastomer (TPEE) resin.

Preferably, the MBS resin may have a rubber content of 60 to 85 parts by weight.

The vegetable oil may include at least one selected from the group consisting of palm oil, coconut oil, castor oil, grape seed oil, jojoba oil, safflower oil, macadamia nuts oil, and olive seed oil.

The thermoplastic polyester elastomer (TPEE) resin may have a Shore hardness of 35 to 50D.

In addition, the soft MBS resin composition may further include 30 to 600 parts by weight of a glycol-modified polyethylene terephthalate (PETG) resin.

The soft MBS resin composition may further include 10 to 30 parts by weight of a filler with respect to 100 parts by weight of the MBS resin composition, wherein the filler is selected from the group consisting of calcium carbonate (CaCO₃), silica and a mixture thereof.

The soft MBS resin composition may further include at least one flame retardant selected from the group consisting of zinc oxide (ZnO), zinc borate (ZnBO₃), Ca—Mo, tristriazine, decabromoniphenyl ethane, octabromodiphenyl oxide, antimony trioxide, antimony pentoxide, aluminum hydroxide, magnesium hydroxide, and polyphosphate.

The soft MBS resin composition may further include a filler, an eco-friendly lubricant, a modifier, or a flame retardant.

The soft MBS resin composition may further include at least one additive selected from the group consisting of a plasticizer, an antioxidant, and a UV absorber.

The present invention may further provide a method for preparing an eco-friendly soft MBS resin that includes: mixing a methylmethacrylate butadiene styrene (MBS) resin and a vegetable oil; and adding a thermoplastic polyester elastomer (TPEE) resin to the resultant mixture.

The present invention may further provide an eco-friendly vinyl leather using the above-specified eco-friendly soft MBS resin.

### Effects of the Invention

Unlike the existing PVC resins, the present invention is eco-friendly without giving off environmental hormone disruptors, and also has excellent properties in regards to weatherability, low-temperature resistance, heat resistance, tensile strength, elongation at break, scratch resistance, adhesiveness, and wear resistance, so it can be suitably used as an alternative material to replace the soft PVC films, sheets, toys, and medical products, as well as bags and constructional or advertising products that conventionally use the existing PVC-based synthetic leather.

### BEST MODES FOR CARRYING OUT THE INVENTION

Hereinafter, the present invention will be described in detail.

The present invention is to develop a soft resin that has properties and processability good enough to replace the soft PVC films, sheets, toys, medical products, and other soft PVC products that conventionally use the existing PVC resin.

The MBS resin is a component made in the form of powder and primarily used as a shock absorber for hard PVC or engineering plastic. With good miscibility and compatibility with other resins, the MBS resin is mainly used to improve the properties and processability of other resins. But, the MBS resin does not have properties good enough to be used alone and is thus impossible to process into commercial products.

Accordingly, the present invention is to prepare a soft MBS resin that employs the MBS resin as a substrate resin but in combination with a thermoplastic polyester elastomer resin in order to produce a soft resin having properties and processability good enough to replace the soft PVC resin.

Thus the present invention provides an eco-friendly soft resin composition that includes a methylmethacrylate butadiene styrene resin, a vegetable oil, and a thermoplastic polyester elastomer resin.

The methylmethacrylate butadiene styrene (MBS) resin is used as a substrate resin.

The MBS resin is preferably a MBS resin that is opaque with high rubber content. More specifically, the MBS resin of which the rubber content is 60 to 85 parts by weight is more preferably, because the miscibility between the MBS resin and the vegetable oil appears good and the MBS resin is miscible with the thermoplastic polyester elastomer resin in the subsequent step, producing a soft MBS resin with excellent properties and processability.

The MBS resin prepared by using less than 60 parts by weight of the rubber content has an insignificant effect of shock absorption and leads to a need of using an excess of a shock absorber in order to improve the resin in regards to the shock strength, so it is not suitable in the aspect of the economy.

The MBS resin can be mixed with oil in order to control the hardness. In this process, the miscibility and compatibility between the resin and the oil are of importance. Poor miscibility and compatibility between the resin and the oil may cause deterioration in the properties and processability of the resin.

Therefore, the oil added to soften the MBS resin is preferably a vegetable oil.

The vegetable oil is preferably an oil extracted from plants or plant seeds. Specific examples of the vegetable oil may include palm oil, coconut oil, castor oil, grape seed oil, jojoba oil, safflower oil, macadamia nuts oil, olive seed oil, etc. Palm oil is particularly preferred.

The content of the vegetable oil is preferably 20 to 130 parts and more preferably 40 to 100 parts by weight, with respect to 100 parts by weight of the MBS resin. The content of the vegetable oil less than 20 parts by weight may lead to an insignificant effect of softening the MBS resin. The content of the vegetable oil greater than 130 parts by weight may deteriorate the miscibility and compatibility with the MBS resin due to the excessive content of the oil and cause blooming that oil exudes on the surface of the sheet, possibly deteriorating the properties and processability of the resin.

After the MBS resin and the vegetable oil are mixed together, a thermoplastic polyester elastomer resin is added to the mixture.

The thermoplastic polyester elastomer (TPEE) resin is an eco-friendly resin that has good properties and processability and good compatibility with the MBS resin to compensate for the properties of the MBS resin.

In other words, the TPEE resin has excellences in the miscibility and compatibility with the MBS resin, more or less good miscibility and high compatibility with the palm oil, and excellent physical properties, such as high tensile strength at high temperature, low compression set, excellences in chemical resistance, low-temperature resistance, weatherability, heat resistance, tensile strength, and so forth, thereby forming a high-quality composition when in combination with the MBS resin. The TPEE resin is also a resin capable of inhibiting the leaching of the palm oil. If possible, the TPEE resin with low melting temperature and low hardness is preferably used.

The TPEE resin may be prepared by performing melt polymerization of aromatic dicarboxylic acid or its ester-forming derivative, aliphatic diol, and polyalkylene oxide according to a known method or by performing solid polymerization of the melt-polymerized TPEE resin.

The TPEE resin preferably has a Shore hardness of 35 to 50D in order to achieve the properties sufficiently.

The content of the TPEE resin is preferably 3 to 150 parts by weight with respect to 100 parts by weight of the MBS resin. The content of the TPEE resin less than 3 parts by weight may lead to an insignificant effect of compensating for the properties of the MBS resin, while the content of the TPEE resin greater than 150 parts by weight may have an adverse effect on the properties of the soft MBS resin due to an excessive amount of the TPEE resin used.

The eco-friendly soft MBS resin composition of the present invention may further include a glycol-modified polyethylene terephthalate (PETG) resin under necessity.

The content of the PETG resin is preferably 30 to 600 parts by weight with respect to 100 parts by weight of the MBS resin. The content of the PETG resin less than 30 parts by weight may lead to an insignificant effect of compensating for the properties of the MBS resin, while the content of the PETG resin greater than 600 parts by weight may increase the hardness of the soft MBS resin without having a softening effect, in which case an addition of oil is needed to soften the MBS resin, but possibly causing the blooming or migration of the oil on the surface.

The PETG resin is relatively inexpensive, with an effect to reduce the production cost, and used in combination with the TPEE resin to enhance the properties of the MBS resin. The PETG resin having a low melting temperature is more preferably used as possible in the preparation of the MBS resin with high quality. More specifically, the melting temperature of the PETG resin is in the range of 80 to 180° C.

The eco-friendly soft MBS resin composition including the above-mentioned components according to the present invention may further include a filler, an eco-friendly lubricant, a flame retardant, a modifier, and so forth.

Specific examples of the filler may include calcium carbonate (CaCO₃), silica, etc. The content of the filler may be 10 to 30 parts by weight with respect to 100 parts by weight of the MBS resin composition.

Specific examples of the lubricant may include various lubricants such as paraffin wax, polyolefin wax, polypropylene wax, stearmide, oleic acid amide, erucic acid aide, erucamide, etc. An eco-friendly lubricant is preferably used.

Specific examples of the flame retardant may include zinc oxide (ZnO), zinc borate (ZnBO₃), Ca—Mo, tristriazine, decabromoniphenyl ethane, octabromodiphenyl oxide, antimony trioxide, antimony pentoxide, aluminum hydroxide, magnesium hydroxide, polyphosphate, etc.

As well, the eco-friendly soft MBS resin composition of the present invention may further include an additive, such as a plasticizer, an antioxidant, a UV absorber, a modifier, and so forth.

The present invention also provides a vinyl leather using the above-specified eco-friendly soft MBS resin. The vinyl leather using the eco-friendly soft MBS resin of the present invention is eco-friendly without giving off environmental hormone disruptors and also excellent in properties, such as weatherability, low-temperature resistance, heat resistance, tensile strength, elongation at break, scratch resistance, adhesiveness, and wear resistance. In addition, the eco-friendly soft MBS resin of the present invention can be used as an alternative material to replace the soft PVC films, sheets, toys, and medical products, as well as bags and constructional or advertising products that conventionally use the existing PVC-based synthetic leather other than the vinyl leather.

Hereinafter, the present invention will be described in further detail with reference to the examples, which are given for the purpose of illustrations only and not intended to limit the scope of the present invention.

### Example 1

In order to determine the compatibility between the methylmethacrylate butadiene styrene (MBS) resin and the vegetable oil depending on the contents of the MBS resin and the vegetable oil, the MBS resin and the vegetable oil are mixed together according to the composition as given in the following table 1 to evaluate the compatibility between them. In this regard, the MBS resin is MB838 or MB872 (manufactured by LG Chem Ltd.) and the vegetable oil is palm oil. The weight unit in Table 1 is kg.

TABLE 1

| Div. | | 1 | 2 | 3 | 4 | 5 | 6 | 7 | 8 |
|---|---|---|---|---|---|---|---|---|---|
| MBS | MB838 | 1.0 | 1.0 | 1.0 | 1.0 | — | — | — | — |
| resin | MB872 | — | — | — | — | 1.0 | 1.0 | 1.0 | 1.0 |

| | | | | | | | | |
|---|---|---|---|---|---|---|---|---|
| Palm oil | 0.4 | 0.6 | 0.8 | 1.0 | 0.4 | 0.6 | 0.8 | 1.0 |

The methylmethacrylate butadiene styrene (MBS) resin is MB872 or MB838 manufactured by LG Chem Ltd.

In mixing the MBS resin and the vegetable oil together, the content of the vegetable oil is increased from 0.4 kg to 1.0 kg by 0.2 kg in a stepwise manner with respect to 1.0 kg of the MBS resin. As a result, the miscibility appears all the same, and the compositions 3, 4, 7, and 8 in which the content of the palm oil is greater than 0.8 kg are in the gel state.

In Table 1, the compositions 1 and 5 take the form of a resin, show properties not good enough for the resin in regards to tensile strength, elongation at break, surface stickiness, etc. even with a small absorbed amount of the palm oil and have the blooming or migration phenomenon on the surface, so they are impossible to process into a desired resin product. In relation to the composition 8, the composition 4 is improved in the properties but not greatly improved in the blooming or migration issue and adhesion. Thus, for the MBS resin, MB838 appears superior to MB872 in terms of the oil absorption and the miscibility with the oil.

### Example 2

As given in Table 2, 0.28 kg, 0.32 kg, 0.36 kg, or 0.40 kg of the thermoplastic polyester elastomer (TPEE) resin is added to each mixture prepared by mixing 0.4 kg, 0.6 kg, 0.8 kg, or 1.0 kg of the palm oil with 1.0 kg of MB838 or MB872 used as the MBS resin. The resultant mixture is heated and then cooled down to observe the change in the state. In Table 2, the weight unit is kg.

TABLE 2

| Div. | | 1 | 2 | 3 | 4 | 5 | 6 | 7 | 8 |
|---|---|---|---|---|---|---|---|---|---|
| MBS | MB838 | 1.0 | 1.0 | 1.0 | 1.0 | — | — | — | — |
| resin | MB872 | — | — | — | — | 1.0 | 1.0 | 1.0 | 1.0 |

| | | | | | | | | |
|---|---|---|---|---|---|---|---|---|
| Palm oil | 0.4 | 0.6 | 0.8 | 1.0 | 0.4 | 0.6 | 0.8 | 1.0 |
| TPEE resin | 0.28 | 0.32 | 0.36 | 0.4 | 0.28 | 0.32 | 0.36 | 0.4 |

(1) Thermoplastic Polyester Elastomer (TPEE) is KP3340 Manufactured by Kolon Industries Inc.

As a result of the addition of the TPEE resin to each mixture of the MBS resin and the palm oil as given in Table 2, the compositions 1, 2, 3, 5, and 6 in which the content of the palm oil is less than 0.8 kg are the compositions having the Shore A hardness of about 90, and the composition 2 and 8 in which the content of the palm oil is 1.0 kg are low-hardness compositions having a Shore A hardness of 70 or below and contain an excess of the palm oil, leading to the failure to obtain compositions with high quality. In addition, the compositions using MB838 or MB872 have the similar results.

### Example 3

1.0 kg of the palm oil is mixed with 1.0 kg of MB838 used as the MBS resin, and the TPEE resin is then added in a different amount of 0.6 kg, 1.0 kg, 1.3 kg, or 1.5 kg to the mixture. The resultant mixture is heated and then cooled down to observe the effect of improving the product quality. The results are presented in Table 3. The quality improvement results of Table 3 are given in comparison with those of the soft PVC (plasticizer concentration of 100 phr and Shore A hardness of about 70). In Table 3, the weight unit is kg.

TABLE 3

| Div. | 1 | 2 | 3 | 4 |
|---|---|---|---|---|
| MB838 resin | 1.0 | 1.0 | 1.0 | 1.0 |
| Palm oil | 1.0 | 1.0 | 1.0 | 1.0 |
| TPEE resin | 0.6 | 1.0 | 1.3 | 1.5 |
| Quality improving | Good | Good | Good | Very good |
| effect | | | | |

As shown in Table 3, the compositions 1, 2 and 3 are similar to the soft PVC in terms of the effect of improving heat resistance, low-temperature resistance and weatherability, somewhat inferior to the soft PVC in the wear resistance on the surface and adhesion, but superior in the elasticity. Further, the composition 4 is considerably more excellent than the soft PVC in regards to the tensile strength and the elongation at break.

### Example 4

As given in Table 4, 1 kg of the MB838 resin is mixed with the palm oil in a different amount in each case and the mixture is then mixed with the TPEE resin and the PETG resin to prepare each soft MBS resin. The soft MBS resins are measured in regards to Shore A hardness, the quality improvement results, specific gravity, tensile strength, and elongation at break. The measurement results are presented in Table 4. In Table 4, the weight unit is kg.

TABLE 4

| Div. | 1-1 | 1-2 | 1 | 2 | 3 | 4 | 5 | 6 | 7 | 8 |
|---|---|---|---|---|---|---|---|---|---|---|
| MB383 | 1.0 | 1.0 | 1.0 | 1.0 | 1.0 | 1.0 | 1.0 | 1.0 | 1.0 | 1.0 |
| Palm oil | 1.6 | 1.3 | 1.3 | 1.0 | 0.7 | 1.0 | 1.0 | 1.3 | 1.3 | 1.3 |
| TPEE | 0.03 | 0.03 | 0.03 | 0.03 | 0.147 | 0.6 | 1.3 | 1.5 | 1.5 | 1.5 |
| PETG | 7.0 | 6.0 | 5.0 | 4.0 | 3.0 | 2.5 | 2.0 | 1 | 0.69 | 0.46 |
| A hardness | 95 ± 3 | D60 ± 3 | 97 ± 3 | 98 ± 3 | 93 ± 3 | 87 ± 3 | 72 ± 3 | 65 ± 3 | 54 ± 3 | 51 ± 3 |
| Quality | | | Good | Good | Good | Good | Good | Good | Good | Good |
| improving | | | | | | | | | | |
| effect | | | | | | | | | | |
| Specific | | | — | 1.16 | 1.13 | 1.12 | 1.10 | 1.13 | 1.18 | — |
| gravity | | | | | | | | | | |
| Tensile | | | — | 209 | 157 | 133 | 58 | 59 | 28 | — |
| strength | | | | | | | | | | |
| (kgf/cm²) | | | | | | | | | | |
| Elongation | | | — | 270 | 330 | 350 | 280 | 255 | 150 | — |
| (%) | | | | | | | | | | |

In Table 4, the composition 2 is similar in hardness to the soft PVC having a plasticizer concentration of 30 phr because of its high-hardness composition, the composition 3 to the soft PVC having a plasticizer concentration of 40 phr, the composition 4 to the soft PVC having a plasticizer concentration of 60 phr, the composition 5 to the soft PVC having a plasticizer concentration of 80 phr, the composition 6 to the soft PVC having a plasticizer concentration of 90 phr, the composition 7 to the soft PVC (about A51±3) having a plasticizer (DOP) content of 100 phr.

In comparison to the composition 7, in Table 4, the composition 8 having a small amount of the PETG resin is similar in hardness but inferior in properties such as tensile strength.

On the other hand, the main purpose of using the PETG resin in the composition is to reduce the production cost by mixing a large amount of the PETG resin as a filler. According to Table 4, the compositions 1, 1-1 and 1-2 contain a large amount of the PETG resin and are subjected to the tests.

In other words, for the sake of maintaining the hardness of the soft PVC in the range of about 30 to 40 phr, 1 kg of the MB838 resin is mixed with the palm oil and the PETG resin, while the content of the palm oil is increased from 1.0 kg to 1.3 kg or 1.6 kg and the content of the PETG resin is increased up to 4.0 to 7.0 kg.

As a result, the compositions 1 and 1-1 in Table 4 are similar in the hardness to the soft PVC having a plasticizer concentration of about 40 phr, and the composition 1-2 is similar in the hardness to the soft PVC having a plasticizer concentration of about 30 phr, with similarity in the properties to the composition 2.

Further, the composition 1 of Table 4 has similarity in the hardness to the soft PVE having a plasticizer concentration of about 30 phr, shows high quality but requires a high production cost in relation to the soft PVC having a plasticizer concentration of about 30 phr.

However, when a large amount of the palm oil is used in the composition as in the case of the composition 1-1 in Table 4, the blooming that the oil exudes on the surface takes place due to such a large amount of the oil added to the MBS resin even if the amount of the PETG resin is increased.

### Example 5

The composition 1 of Table 4 according to the Example 4 has a similar hardness to the soft PVC having a plasticizer concentration of about 30 phr and good quality but is expensive relative to the soft PVC having a plasticizer concentration of phr. Therefore, 1 kg of the MB838 is mixed with the PETG resin used as a filler to reduce the production cost and the palm oil used to maintain a hardness of the composition 2 of Table 4 similar to the hardness of the soft PVC having a plasticizer concentration of 30 phr, while the content of the PETG resin is increased from 4 kg to 7 g in a stepwise manner and the content of the palm oil is increased from 1 kg to 1.6 kg in the stepwise manner. The resultant compositions are then measured in regards to the Shore A hardness.

The measurement results are presented in Table 5. In Table 5, the weight unit is kg.

TABLE 5

| Div. | 1 | 2 | 3 | 4 |
|---|---|---|---|---|
| MB838 | 1.0 | 1.0 | 1.0 | 1.0 |
| Palm oil | 1.0 | 1.3 | 1.3 | 1.6 |
| TPEE resin | 0.03 | 0.03 | 0.03 | 0.03 |
| PETG resin | 4.0 | 5.0 | 6.0 | 7.0 |
| Shore A | 98 ± 3 | 97 ± 3 | D60 ± 3 | 95 ± 3 |
| hardness | | | | |

In Table 5, the compositions 1 and 2 are similar in the hardness to the soft PVC having a plasticizer concentration of about 40 phr, the composition 3 to the soft PVC having a plasticizer concentration of about 30 phr, the composition 4 to the PVC having a plasticizer concentration of about 50 phr.

In terms of the properties, the compositions 1, 2 and 3 of Table 5 appear similar to the composition 2 of Table 4, and the composition 4 of Table 5 has the blooming phenomenon even when the PETG content is increased due to a large amount of the oil used. Accordingly, the compositions of Table 5 have all the same results of the composition 2 of Table 2 even when the content of the oil is increased in the range of 1.0 to 1.3 kg and the content of the PETG resin is increased up to 6.0 kg, thereby eventually leading to a great reduction of the production cost.

The present invention has been described with reference to the particular illustrative examples, which are susceptible to many changes and modifications without departing from the scope and spirit of the present. All such changes and modifications are deemed to be covered by the claims of the present invention that follow.

1. An eco-friendly soft methylmethacrylate butadiene styrene (MBS) resin composition comprising:
100 parts by weight of a MBS resin;
20 to 130 parts by weight of a vegetable oil; and
3 to 150 parts by weight of a thermoplastic polyester elastomer (TPEE) resin.

2. The eco-friendly soft MBS resin composition as claimed in claim 1, wherein the MBS resin has a rubber content of 60 to 85 parts by weight.

3. The eco-friendly MBS resin composition as claimed in claim 1, wherein the vegetable oil comprises at least one selected from the group consisting of palm oil, coconut oil, castor oil, grape seed oil, jojoba oil, safflower oil, macadamia nuts oil, and olive seed oil.

4. The eco-friendly soft MBS resin composition as claimed in claim 1, wherein the thermoplastic polyester elastomer (TPEE) resin has a Shore hardness of 35 to 50D.

5. The eco-friendly soft MBS resin composition as claimed in claim 1, wherein the composition further comprises 30 to 600 parts by weight of a glycol-modified polyethylene terephthalate (PETG) resin.

6. The eco-friendly soft MBS resin composition as claimed in claim 1, wherein the soft MBS resin composition further comprises 10 to 30 parts by weight of a filler with respect to 100 parts by weight of the MBS resin composition, wherein the filler is selected from the group consisting of calcium carbonate (CaCO₃), silica and a mixture thereof.

7. The eco-friendly soft MBS resin composition as claimed in claim 1,
wherein the soft MBS resin composition further comprises at least one flame retardant selected from the group consisting of zinc oxide (ZnO), zinc borate (ZnBO₃), Ca—Mo, tristriazine, decabromodiphenyl ethane, octabromodiphenyl oxide, antimony trioxide, antimony pentoxide, aluminum hydroxide, magnesium hydroxide, and polyphosphate.

8. The eco-friendly soft MBS resin composition as claimed in claim 1, wherein the soft MBS resin composition further comprises a filler, an eco-friendly lubricant, a modifier, or a flame retardant.

9. The eco-friendly soft MBS resin composition as claimed in claim 1, wherein the soft MBS resin composition further comprises at least one additive selected from the group consisting of a plasticizer, an antioxidant, and a UV absorber.

10. A method for preparing an eco-friendly soft MBS resin, comprising:
mixing a methylmethacrylate butadiene styrene (MBS) resin and a vegetable oil; and
adding a thermoplastic polyester elastomer (TPEE) resin to the resultant mixture.

11. An eco-friendly vinyl leather using the eco-friendly soft MBS resin as claimed in claim 1.
